(19) United States
(12) Patent Application Publication
(10) Pub. No.: US 2019/0391776 A1
(43) Pub. Date: Dec. 26, 2019

(54) SYSTEMS AND METHODS FOR RE-ORDERING QUEUED PRINT JOBS

(71) Applicant: XEROX CORPORATION, Norwalk, CT (US)

(72) Inventors: Srinivasarao Bindana, Kakinada (IN); Liya Stanley, Thrissur District (IN); Dipikaa Ashokan, Chennai (IN)

(21) Appl. No.: 16/016,702

(22) Filed: Jun. 25, 2018

(51) Int. Cl. G06F 3/12

(52) U.S. Cl. CPC G06F 3/1263; G06F 3/1288; G06F 3/1238; G06F 3/1222

(57) ABSTRACT

The present disclosure discloses systems and methods for re-ordering queued print jobs. The method includes executing one or more already received print jobs listed in a print queue of a printer. Then, a new print job is received in the print queue of the printer. A message is displayed to the user with an option to re-order the new print job, via a user interface. Based on the user input, the new print job is re-ordered by moving the new print job to the top of the print queue of the printer. Finally, the new print job is printed first followed by printing the one or more already received print jobs.

### TECHNICAL FIELD

The present disclosure relates to the field of printing, more specifically, relates to methods and systems for re-ordering queued print jobs.

### BACKGROUND

Multi-function printers (MFP) often face the issue of paper exhaustion in the middle of printing and print jobs are queued up without printing when there are no papers in the multi-function printers. In such scenarios, when a user manually reloads papers in a paper tray of the MFP, the list of queued print jobs resumes printing, i.e., old jobs are printed first, and the user has to wait for his own job to be completed, which may be queued last. Further, the problem of paper exhaustion may occur again as the papers loaded in the tray are handful because the user is unaware of the prior jobs listed in in the print queue and their required page count. Moreover, secured print jobs from the print queue are left unattended and thereby causes security issues. In view of these concerns, there is a need for efficient methods and systems to overcome the mentioned problems.

### SUMMARY

According to aspects illustrated herein, a method for re-ordering one or more print jobs listed in a print queue of a printer is disclosed, the method is implemented by the printer. The method includes executing one or more already received print jobs listed in a print queue of a printer. A new print job is received in the print queue of the printer, the new print job is submitted by a user. A set of papers is received in a paper supply tray of the printer. The set of papers is detected as inserted in the paper supply tray of the printer. A message is displayed to the user with an option to re-order the new print job, via a user interface. Based on the user input, credentials of the user are received. Based on the received credentials of the user, it is checked whether the user belongs to an authorized group of users. Based on the check, the new print job is re-ordered by moving the new print job to the top of the print queue of the printer. The new print job is printed first followed by printing the one or more already received print jobs.

According to further aspects illustrated herein, a printer including a paper supply tray, a user interface and a printer controller, is disclosed. The paper supply tray is configured for receiving a set of papers. The user interface is configured for displaying a print queue listing one or more already received print jobs for printing. The print controller is in communication with the paper supply tray and the user interface. The print controller is configured for: executing the one or more already received print jobs; receiving a new print job in the print queue as submitted by a user, the new print job is added to the print queue; receiving a set of papers in the paper supply tray; detecting the set of papers as inserted by the user in the paper supply tray; displaying a message to the user with an option to re-order the new print job submitted by the user; based on the user input, receiving credentials of the user; based on the received credentials of the user, checking whether the user belongs to an authorized group of users; based on the check, re-ordering the new print job by moving the new print job to the top of the print queue; and printing the re-ordered new print job first followed by printing the one or more already received print jobs.

According to additional aspects illustrated herein, a method includes receiving a new print job in a print queue of a printer, the print queue of the printer including one or more already received print jobs. A user interface is presented to a user with an option to re-order the new print job. Based on the user input, the new print job is prioritized by moving the new print job to the top of the print queue. A currently executed print job of the one or more already received print jobs, is paused. The new print job is printed. Then, printing of the currently executed print job of the one or more already received print jobs, is resumed.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 illustrates an exemplary environment in which various embodiments of the disclosure can be practiced.

FIG. 2A is a block diagram of a system for re-ordering queued print jobs; FIG. 2B. shows an exemplary printer device as shown in FIG. 2A.

FIGS. 3A and 3B represent a method flowchart for re-ordering queued print jobs, according to an embodiment of the disclosure.

FIGS. 4A, 4B, 4C and 4D show various snapshots of a user interface, according to exemplary embodiments of the disclosure.

### DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Non-Limiting Definitions

Definitions of one or more terms that will be used in this disclosure are described below without limitations. For a person skilled in the art, it is understood that the definitions are provided just for the sake of clarity and are intended to include more examples than just provided below.

The term “printer” refers to a device or a combination of multiple devices configured to perform printing. In addition to printing, the printer may perform one or more functions, but not limited to, scanning, copying, imaging, and so forth. The printer includes software, hardware, firmware, or a combination thereof. In context of the current disclosure, the printer re-orders one or more print jobs listed in a print queue, i.e., queued print jobs. The printer includes one or more components to re-order the queued print jobs.

The “queued print jobs” include one or more already received print jobs and a new print job. The one or more already received jobs include one or more print jobs submitted by one or more users at a time T. The one or more already received jobs may be secure print job or normal print jobs or a combination thereof. The queued print jobs may simply be referred to as one or more print jobs queued in the print queue of the printer.

The “new print job” includes a print job submitted by a user such as an authorized user at a time T1, i.e., the new print job is submitted after the one or more already received print jobs. The new print job includes a print job which is a high priority job compared to the one or more already received print jobs. The new print job is a secure print job. The new print job is queued after the one or more already received print jobs, i.e., queued last.

A “current print job,” includes a print job of the one or more already received print jobs that is currently being executed by the printer.

The term “re-ordering” refers to changing a pre-defined order in which the print jobs are queued in the print queue of the printer. The re-ordering may interchangeably be used with the term “re-arranging,” or “prioritizing,” or “changing.”

The term “an authorized user” refers to a user who has rights to re-order the queued print jobs. The authorized user belongs to a specific group who has more permission than the regular users to manage his print job. The authorized user may be a chief executive of an organization, Information technology (IT) users, an owner of the organization, a leader of the organization, senior executive officer, or an administrator who manages the organization.

The term “loading” refers to inserting a set of papers in a paper supply tray of the printer. The set of papers may be standard papers or custom papers. The term loading may include re-loading the set of papers.

### Overview

In current scenarios, a number of solutions exist to re-order the print jobs, but the existing solutions are more complex and less foolproof. For example, the existing solutions focus on programming all print jobs to use custom stock, submit all print jobs as secure jobs, disable all trays, load a single tray with custom stock and release the print jobs. When a user reloads the papers in a printer, the queued-up jobs automatically resume, and they are printed in the same order as listed in the print queue. However, by implementing the present disclosure, a message such as a pop-up message is presented to the user to choose between resuming the queued-up print jobs and reordering the list of queued-up print jobs, thereby, enabling the user to prioritize his own existing print job or add a new print job to the top of the print queue.

The present disclosure further addresses scenarios when there is a paper exhaustion and there is a need to load/reload a paper supply tray. A user loads/reloads the paper supply tray. Moreover, the present disclosure addresses scenarios when a user simply wants to prioritize his print job over multiple print jobs that are already queued in the printer. In both the scenarios, the present disclosure enables the user to re-order the queued print jobs and this will be discussed below in greater detail.

Here, the user is an authorized user has the rights to prioritize his print job (i.e., a new print job) over the multiple queued-up print jobs. As per the current disclosure, prioritizing the new print job can be restricted only to a specific number of users (using Lightweight Directory Access Protocol authentication—Separate Security Group). LDAP authentication is known and thus can be referred to. The users who are a part of the specified security group are able to access a re-order print function in the printer. This avoids the issues, when multiple users come and prioritize their own jobs and the chaos created in such situations.

The present disclosure discloses methods and systems for re-ordering one or more print jobs present in a print queue of a printer. The one or more print jobs are re-ordered when a user loads a set of papers in a paper supply tray or when there is a paper exhaustion. The one or more print jobs are re-ordered when a print job needs to be prioritized. The one or more print jobs include one or more already received print jobs and a new print job. Upon receiving the set of papers, the printer presents an option to the user if he wishes to re-order the one or more print jobs/prioritize the new print job. The printer also presents an option to re-order, when the user selects a re-order print function provided in the user interface. Post receiving an input from the user, the one or more already received print jobs in the queue are put on hold, and the new print job is prioritized. The printer then starts printing the new print job. Once printing of the new print job is completed, the one or more already received print jobs are resumed and are processed further. The methods and systems further allow the user to add one or more new print jobs, the one or more new print jobs can be prioritized.

### EXEMPLARY EMBODIMENTS

According to aspects illustrated herein, a method for re-ordering one or more print jobs listed in a print queue of a printer is disclosed, the method is implemented by the printer. The method includes executing one or more already received print jobs listed in a print queue of a printer. A new print job is received in the print queue of the printer, the new print job is submitted by a user. A set of papers is received in a paper supply tray of the printer. The set of papers is detected as inserted in the paper supply tray of the printer. A message is displayed to the user with an option to re-order the new print job, via a user interface. Based on the user input, credentials of the user are received. Based on the received credentials of the user, it is checked whether the user belongs to an authorized group of users. Based on the check, the new print job is re-ordered by moving the new print job to the top of the print queue of the printer. The new print job is printed first followed by printing the one or more already received print jobs.

The set of papers belongs to a custom set of papers. The method includes providing an option to the user to add one or more new print jobs. The one or more new print jobs are added from at least one of a Universal Serial Bus (USB), a network and a printer memory. The method includes checking whether the print queue is empty. The new print job is a secure print job. The method includes resuming printing of the one or more already received print jobs. The method includes allowing the user to re-order the new print job in a pre-defined time. The method includes updating the print queue of the printer. The method is implemented by a non-transitory computer readable storage medium.

According to further aspects illustrated herein, a printer including a paper supply tray, a user interface and a printer controller, is disclosed. The paper supply tray is configured for receiving a set of papers. The user interface is configured for displaying a print queue listing one or more already received print jobs for printing. The print controller is in communication with the paper supply tray and the user interface. The print controller is configured for executing the one or more already received print jobs; receiving a new print job in the print queue as submitted by a user, the new print job is added to the print queue; receiving a set of papers in the paper supply tray; detecting the set of papers as inserted by the user in the paper supply tray; displaying a message to the user with an option to re-order the new print job submitted by the user; based on the user input, receiving credentials of the user; based on the received credentials of the user, checking whether the user belongs to an authorized group of users; based on the check, re-ordering the new print job by moving the new print job to the top of the print queue; and printing the re-ordered new print job first followed by printing the one or more already received print jobs.

The set of papers belongs to a custom set of papers. The set of papers belongs to standard set of papers.

The user interface is configured for providing an option to the user to add one or more new print jobs. The one or more new print jobs are added from at least one of: a Universal Serial Bus (USB), a network and a printer memory. The print controller is configured for checking whether the print queue is empty. The new print job is a secure print job. The print controller is configured for allowing the user to re-order the new print job in a pre-defined time.

According to additional aspects illustrated herein, a method includes receiving a new print job in a print queue of a printer, the print queue of the printer includes one or more already received print jobs. A user interface is presented to a user with an option to re-order the new print job. Based on the user input, the new print job is prioritized by moving the new print job to the top of the print queue. A currently executed print job of the one or more already received print jobs, is paused. The new print job is printed. Then, printing of the currently executed print job of the one or more already received print jobs, is resumed.

The method includes providing an option to the user to add one or more new print jobs. The one or more new print jobs are added from at least one of a Universal Serial Bus (USB), a network and a printer memory. The new print job is a secure print job. The user interface is presented with an option to re-order the new print job, when a set of papers is inserted by the user in a paper supply tray. The user interface is presented with an option to re-order the new print job, when the user selects a re-order function provided in the user interface. The user is an authorized user.

### Exemplary Environment

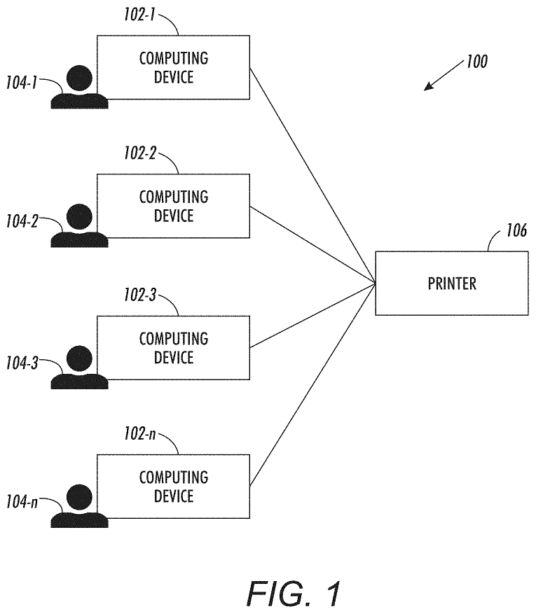

FIG. 1 is an exemplary environment 100 in which various embodiments of the disclosure can be practiced. The environment 100 includes one or more computing devices such as 102-1, 102-2, 102-3 . . . 102-n (collectively, 102), and one or more users 104-1, 104-2, 104-3 . . . 104-n (collectively, 104) and a printer 106. The printer 106 is communicatively coupled to the one or more computing devices 102 via a network (although not shown). The network may be a wired network, a wireless network or a combination of these. The network may be an individual network or a collection of many such individual networks, interconnected with each other and functioning as a single large network, for example, the Internet or an intranet. The network may be implemented as one of the different types of networks, such as intranet, local area network (LAN), wide area network (WAN), the internet, near field communication (NFC), and such networks. The network may either be a dedicated network or a shared network, which represents an association of the different types of networks that use a variety of protocols. The network may include network devices, such as network switches, hubs, routers, HBAs (Host Bus Adapters), for providing a communication link between the printer 106 and other connected devices/systems such as the computing devices 102.

The printer 106 is just one example, the environment 100 may include a multi-function device, a multi-function printer, a multi-function peripheral device, or any equivalent device having printing functionality.

The computing devices 102 are used by the users 104 for day-to-day tasks such as work, internet surfing, reading, games or the like. As shown, the user 104-1 uses the computing device 102-1, the user 104-2 uses the computing device 102-2, the user 104-3 uses the computing device 102-3 and the user 104-n uses the computing device 102-n. Various examples of the computing devices 102 include, but not limited to, a personal computer, a laptop, a mobile device, a personal digital assistant (PDA), or any other device capable of data communication. Using the computing devices 102, the users 104 submit one or more print requests, which are received by the printer 106. The print requests include one or more documents for printing. In an example, a print request may include a single document for printing. In another example, a print request may include more than one document for printing, for example, 2 documents, 3 documents, and so on. The one or more users 104 use the printer 106 for his day-to-day activities such as printing the document, checking status of print jobs, imaging functions, and so forth.

The print requests/jobs are received by the printer 106 that are listed or queued in a print queue of the printer 106. The print jobs are submitted by the users 104 at a different time interval and the print jobs are queued accordingly, i.e., on a first-in first-out (FIFO) basis. The print jobs are queued in the print queue in a pre-defined order, i.e., on a first-come first-out basis. The queued print jobs include one or more already received print jobs such as submitted by the computing devices 102-1 and 102-2 and a new print job such as submitted by the computing device 102-3. The one or more already received print jobs may be normal print jobs while the new print job may be a high priority print job.

In context of the current disclosure, the printer 106 re-orders the queued print jobs. The queued print jobs are considered for re-ordered when a set of papers is loaded or re-loaded in the printer 106 or when an authorized user such as the user 104-3 prioritizes his print job over the remaining queued print jobs. The set of papers may be a normal stack of papers or may include custom papers such as letter heads. Other examples of the custom papers may include bond papers, legal papers, postal covers (for address printing), and so on. The set of papers may be loaded when the set of papers in the paper supply tray is finished. The set of papers may be loaded when the user wants to prioritize his job. When the set of papers is loaded to the printer 106, the printer 106 displays a list of queued/unfinished print jobs with their completion status. The printer 106 further displays an option to the user for re-ordering the queued print jobs. For example, an option may be displayed to the user via a user interface, i.e., 1) “To resume the queued jobs;” 2) “To reorder the print jobs in the print queue.”

Based on an input from the user to the displayed option, the printer 106 re-orders the queued print jobs by moving the new print job to the top of the print queue of the printer 106. The printer 106 prints the new print job followed by printing the one or more already received print jobs. In this manner, the present disclosure enables an authorized user to prioritize his print job from the queued stack.

### Exemplary System

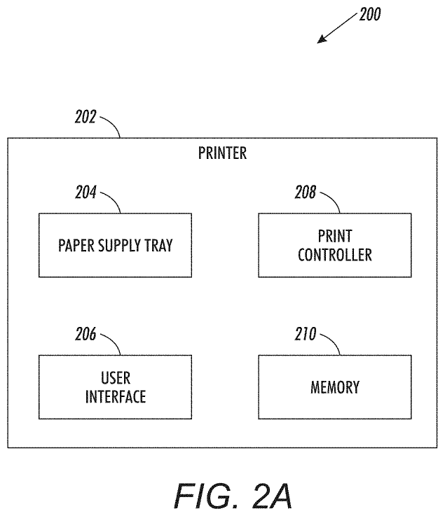

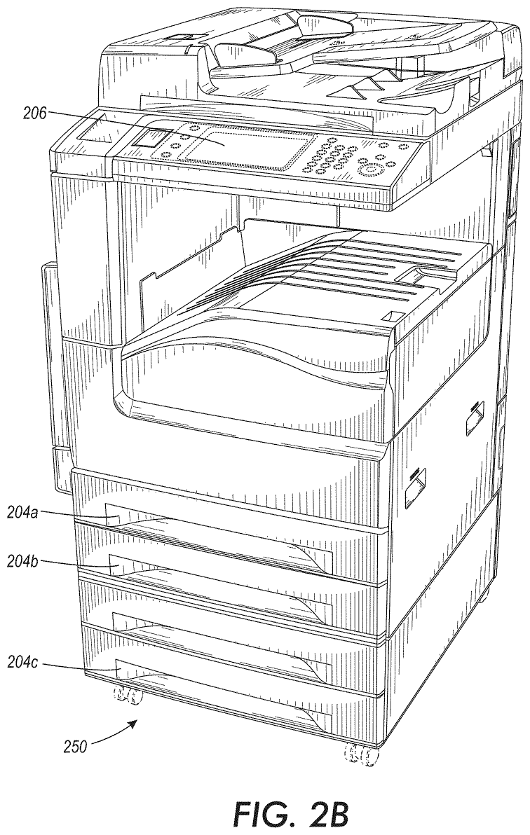

FIG. 2A shows a system 200 having one or more components for re-ordering queued print jobs. As shown, the system 200 includes a printer 202 and one or more computing devices (although not shown in FIG. 2A, refer to FIG. 1). The printer 202 includes a paper supply tray 204, a user interface 206, a print controller 208, and a memory 210. One exemplary view 250 of the printer 202 is shown in FIG. 2B. The view 250 shows one or more paper supply trays such as 204a, 204b, and 204c (collectively, 204) and the user interface 206. The view 250 of the printer 202 shown in FIG. 2B is exemplary in nature and may include other variations of the paper supply trays 204 and the user interface 206. Each of the components 204, 206, 208, and 210 are coupled to each other via a communication bus or later developed protocols and each of the components communicate with each other for re-ordering the queued print jobs. The printer 202 may include one or more additional components as required to implement the current disclosure.

The queued print jobs include all print jobs present in a print queue of the printer 202. The print jobs are queued and executed in a pre-defined order, i.e., on first-come first-serve basis. The queued print jobs are processed and are printed in the same order as the print jobs are listed in the print queue. Further, the queued print jobs include one or more already received print jobs submitted by one or more users and a new print job submitted by an authorized user. The new print job is a secure print job. The one or more already received print jobs may or may not be secure print jobs.

The paper supply tray 204 is configured for receiving a set of papers. In one example, the paper supply tray 204a may be loaded with standard stock of papers, i.e., A4 size white papers. In another example, the paper supply tray 204c may be loaded with custom stock such as A4 size letter heads. The set of papers may be loaded/re-loaded by the authorized user. The set of papers may include normal papers or may include custom papers. The set of papers may be loaded when the paper supply tray 204 is completely empty or partially empty. The set of papers may be loaded when the authorized user wishes to re-order the queued print jobs, i.e., to prioritize the new print job over the one or more already received print jobs. Each time when the paper supply tray 204 is loaded, a pop message is presented to the authorized user for prioritizing his print job, i.e., a new print job (or for re-ordering the queued print jobs).

The user interface 206 is configured for displaying the print queue listing the queued print jobs. The user interface 206 further displays completion status of the queued print jobs, allows users to change settings, allows users to input credentials and so on. In context of the current disclosure, the user interface 206 provides an option to the authorized user to re-order the queued print jobs. The option is presented when the set of paper is loaded/inserted in the paper supply tray 204. The option is presented when the authorized user selects a re-order print function as provided in the user interface 206. The user interface 206 is further presented with an option to add one or more new print jobs. The one or more new print jobs are added from at least one of: a Universal Serial Bus (USB), a network and the printer memory 210. This will be discussed below in greater detail.

The print controller 208 is configured for executing the queued print jobs, the queued print jobs are listed in the print queue of the printer 202. The queued print jobs are received by the print controller 208 via a network for processing. The print controller 208 detects the set of papers as loaded or re-loaded in the paper supply tray 204 of the printer 202. The paper supply tray 204 is loaded by the authorized user. Upon detecting, the print controller 208 displays a message to the authorized user with an option to re-order the queued print jobs, i.e., to prioritize the new print job, via the user interface 206. The print controller 208 allows the authorized user to re-order the print jobs within a pre-defined time period such as 10 seconds, 20 seconds, 1 minute and so on. Based on the user input to the displayed message, the print controller 208 requests the authorized user to input his credentials. And the print controller 208 receives credentials of the authorized user. Based on the received credentials, the print controller 208 checks whether the authorized user belongs to a group of pre-defined authorized users. For authorization and authentication, the printer 202 can be integrated with LDAP (Lightweight Directory Access Protocol) server and this is well known in the art and does not interfere while implementing the current disclosure.

Based on the check, the print controller 208 re-orders the queued print jobs by moving the new print job to the top of the print queue of the printer 202. The print controller 208 puts the one or more already received print jobs on hold and prints the new print job first, followed by printing the one or more already received print jobs in the print queue. The print controller 208 additionally checks whether the print queue is empty. Post completion of printing the new print job, the print controller 208 resumes printing of the one or more already received print jobs. The one or more already received print jobs are printed by the printer 202 in the same order as the one or more already received print jobs are listed in the print queue.

The printer memory 210 stores the all print jobs as received via the network. The memory 210 further stores a list of pre-defined authorized users who are allowed to re-order the print queue. The list of pre-defined authorized users can be defined by an admin user or can be modified anytime. The memory 210 stores credentials of the pre-defined authorized users. The memory 210 stores all relevant details required for implementing the present disclosure.

### Exemplary Case Scenarios

For better understanding, a few exemplary case scenarios are discussed without limiting the scope of the disclosure and other variations to the case scenarios may be implemented. As discussed in FIG. 2A, the system 200 of the present disclosure allows authorized users to re-order their print jobs. In one scenario, an authorized user wishes to print his job on a custom stock of papers such as letter heads and the paper supply tray only includes standard papers. As a next step, the authorized user loads the custom stock of papers in the paper supply tray. The loading of tray is detected by the printer and an option to re-order the print queue is presented to the user. In further scenario, the authorized user wishes to print his job on a standard stock of papers and the paper supply tray is empty or does not contain sufficient papers for printing his job. In such scenarios, the authorized user loads the standard papers in the paper supply tray. The loading of tray is detected by the printer and an option to re-order the print queue is presented to the authorized user. In another scenario, the authorized user wishes to print his job on a standard stock of papers and the paper supply tray includes sufficient standard papers for printing his job. In such scenarios, the authorized user directly uses a re-order print function provided in the user interface. In an additional scenario, a user loads a set of paper in the tray may be standard papers or custom papers, an option to re-order the print queue may be presented to the user. And the user is further requested to provide his credentials and based on the credentials, if the user is determined to be a non-authorized user, his print job is not prioritized. In this manner, the present disclosure only allows the authorized user to re-order the queued print jobs/prioritize their print jobs.

The print job submitted by the authorized user may or may not include any parameters indicating a priority of the print job and thus, the print job of the authorized user can be prioritized as discussed above.

### Exemplary Flowchart

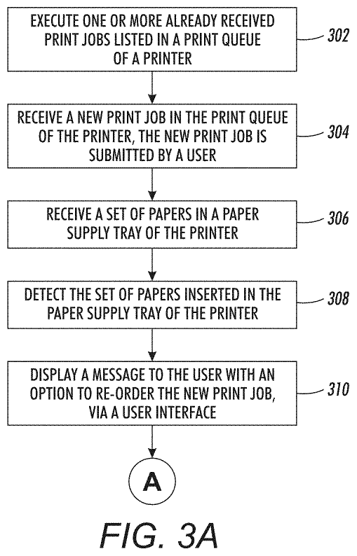

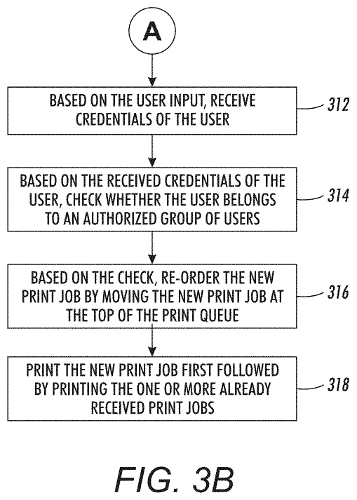

FIGS. 3A and 3B represent a method for re-ordering one or more print jobs listed in a print queue of a printer, the method is implemented by the printer. The method begins with receiving multiple print jobs as submitted by one or more users via a network. The print jobs are listed in a print queue of the printer and are referred to as one or more already received print jobs. The print jobs are processed by the printer in the same order as received by the printer. At 302, the one or more already received print jobs are executed as listed in the print queue of the printer.

At 304, a new print job is received in the print queue of the printer, the new print job is submitted by a user. The user is an authorized user. A set of papers is received in a paper supply tray of the printer, at 306. Then, at 308 the set of papers inserted by the user in the paper supply tray of the printer is detected. The set of papers belongs to a custom set of papers. After the set of papers is loaded to the paper supply, it is checked whether the print queue is empty. If the print queue is empty, the methods proceeds with conventional way of printing. Else, the method proceeds to 310 in context of the current disclosure.

Post detection, a message is displayed to the user with an option to re-order the new print job as submitted by the authorized user at 310, via a user interface. The user is allowed to re-order the new print job in a pre-defined time such as 10 seconds. The pre-defined time can be configured or modified by the print controller 208. If the user responds to the option within the pre-defined time, the method proceeds with re-ordering the queued print jobs. Else, the method proceeds with executing the queued print jobs in the same order as listed in the print queue.

The option includes whether the user wants to proceed with resuming the queued print jobs or the user wants to re-order the queued print jobs. If the user chooses to proceed with resuming the queued print jobs, the method proceeds with executing the queued print jobs in the same order as listed in the print queue. If the user chooses to proceed with re-ordering the queued print jobs, the method proceeds further. Here, the method includes requesting the user to input credentials such as a user name, a password, a user id, or a combination thereof.

Based on the user input, at 312, credentials of the user are received such as a user name and a password. In another example, the credentials may be a user id, an employee id, a password, a pin or a combination thereof. Based on the received credentials of the user, at 314, it is checked whether the user belongs to an authorized group of users. The credentials of the user are checked with a list of authorized group of users stored in the memory.

Upon checking, if the user belongs to the authorized group of users, the method proceeds with the block 316, else the method stops. After checking, a print job (i.e., a new print job) corresponding to the authorized user is identified from the listed queued print jobs.

At 316, the new print job is re-ordered by moving the new print job to the top of the print queue. Here, the print queue is updated, where the new print job is listed to the top of the queue and the one or more already received print jobs are listed below the new print job. Thereafter, a currently executed print job of the one or more already received jobs is put on hold or paused.

Then, printing of the new print job is initiated. Finally, at 318, the new print job is printed first followed by printing the one or more already received print jobs. When printing of the new print job is completed, printing of the one or more already received print jobs is resumed. In particular, printing of the currently executed print job of the one or more already received print jobs is resumed and finally printed. Subsequently, the remaining one or more already received print jobs are printed.

In addition to the above, the method includes providing an option to the user to add one or more new print jobs. The option is provided via the user interface. The one or more new print jobs are added from at least one of a Universal Serial Bus (USB), a network and a printer memory. This option may be provided to the user when the new print job is prioritized or may be provided at later stage. In one example, the new print jobs may be stored in the USB and thus can be added to the print queue of the printer. In another example, the new print jobs may be added via a network such as stored on a server. In further example, the one or more new print jobs may be stored in the printer memory 210 and thus, may be selected via the user interface 206 of the printer 202. Once selected, the one or more new print jobs are stored in the memory 210 of the printer 202 for further processing. The one or more new print jobs are added to the print queue of the printer and the print queue is updated. The one or more new print jobs added by the user are prioritized over the one or more already received print jobs. The one or more new print jobs are moved to the top of the print queue of the printer and executed before other print jobs listed in the queue.

The method is implemented by the non-transitory computer readable storage medium.

The methods and systems focus on re-ordering queued print jobs. An option to re-order print jobs is provided automatically upon detection of a set of papers as inserted in a paper supply tray. An option to re-order print jobs is provided via a re-order print function, the re-order print function is provided to a user (authorized user) via the user interface. The user can access the re-order print function simply via the user interface. By accessing the re-order print function, the user can move his print job to top of the print queue or can prioritize his print job over all print jobs present in the print queue. Re-ordering the print jobs includes re-ordering a print job (i.e., a print job submitted by the authorized user such as a new print job) by moving the new print job to top of the print queue of the printer. Re-ordering the print job also includes re-ordering the print queue by moving the new print job to top of the print queue of the printer.

The methods and systems only allow an authorized user to re-order the print jobs. The user who is able to re-order the print jobs is considered as an authorized user. The authorized user re-orders the print jobs by moving his print job to the top of the print queue of the printer.

A print job submitted by the authorized user may be a priority job or a normal job but if the authorized user wishes to print his print job first, the print job may be considered as a priority job in all such scenarios.

Although the present disclosure discusses re-ordering or prioritizing a print job when a set of papers is loaded in the paper supply tray, however, the present disclosure can also be implemented for other case scenarios. For example, the present disclosure can be implemented for case scenarios when there are sufficient papers in the paper supply tray and the required type of the papers in the paper supply tray, may be custom stock or standard stock. In all such cases, an authorized user can prioritize his print jobs by accessing a re-order print function provided in the user interface.

### Exemplary Snapshots

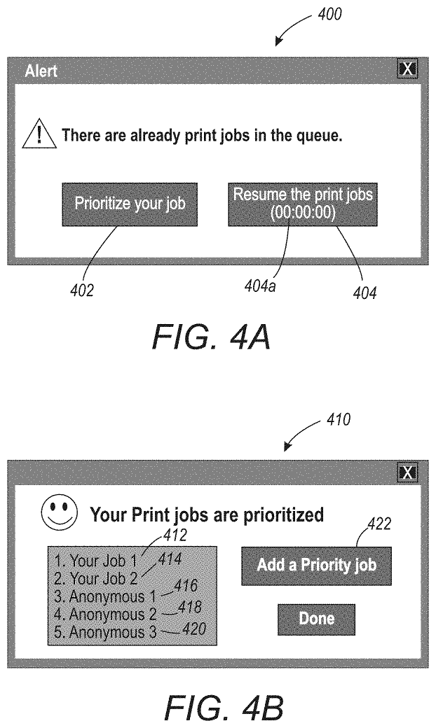

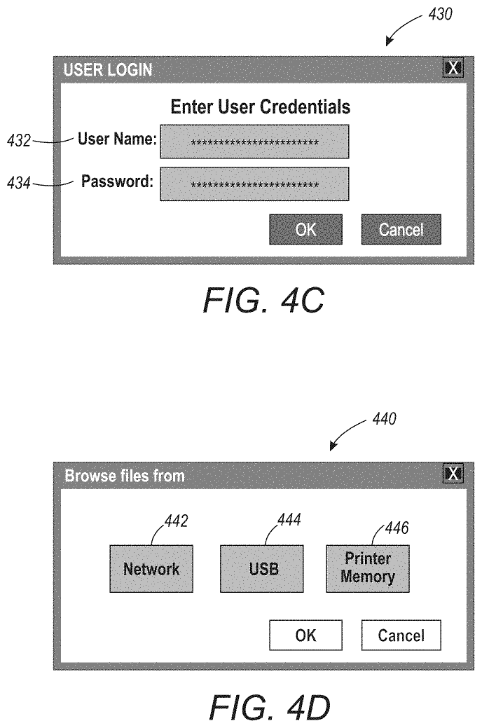

FIGS. 4A-4D show a few exemplary snapshots of a user interface, for better understanding of the present disclosure. A snapshot 400 of FIG. 4A displays a pop-up message or an alert with two options marked as 402 and 404. The pop-up message is displayed when the user loads the paper supply tray, or when the user accesses a re-order feature of the printer. The option 402 displays “prioritize your job,” whereas the option 404 is to “resume the print jobs.” If the user does not respond to any of the options 402 or 404 within a pre-defined time interval (marked as 404a), then the option 404 is automatically considered. If the user chooses the option 402, print jobs such as 412, 414 are prioritized and print jobs 416, 418 and 420 are listed below the print jobs 412, 414 and this is shown in the snapshot 410 of FIG. 4B. As shown, the jobs 412 and 414 are moved to top of the print queue of the printer. In this manner, the queued print jobs are re-ordered. The user is further provided with an option, marked as 422, to add a job such as a priority job. When the user selects the option 422, a prompt is generated for the user to enter credentials username (432) and password (marked with 434) as depicted in the snapshot 430 of FIG. 4C. Post verifying the credentials (432, 434), the user is provided with multiple options as 442, 444, and 446 to add the print job as shown in the snapshot 440 of FIG. 4D. By selecting the option 442, the user can add the priority job via a network. Using the option 444, the user can add the priority job via a USB and the user can further add the priority job via the printer memory by selecting the option 446.

The present disclosure discloses methods and systems for re-ordering queued print jobs. The disclosed methods and systems save up a lot of time of a user (i.e., an authorized user) as his print job gets prioritized first and thus, there is practically zero wait time. The methods and systems provide a simple approach where the user only needs to load up enough papers for his/her own documents to be printed as he is aware of the number of pages to be printed for his print job. Further, the methods and systems enable the user to load sufficient set of papers for his secure print job, to prioritize the print job and to remove the option for a secure document to fall into other's view and thereby, solves the problem of leaving secure print job as unattended by the user. The methods and systems solve the major issue of security of the printed documents and further save precious resources as the user can directly place his own job to the top of the queue, cutting off waiting time. The methods and systems enable authorized users to prioritize their print jobs to complete ahead of any other jobs in the queue as well as to add additional jobs to be printed before processing the remainder of the print queue. The methods and systems facilitate an improved workflow for authorized users who print on custom stock, particularly when it is necessary to control which documents are printed on that stock. The methods and systems help authorized users not to waste their time, waiting for other jobs to print, whose owners are not near the printer. The methods and systems improve user experience for re-ordering queued print jobs.

The present disclosure addresses scenarios in organization when a device such a printer or a multi-function device is placed in a shared-use environment; when an authorized user wants to print a job using a specific stock (such as a letterhead), he walks-up to the printer, loads his specific stock, and then prints only his job on the specific stock, without other print jobs in the queue potentially using it.

The present disclosure should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present disclosure is directed upon review of the present specification. The claims are intended to cover such modifications and devices.

For a person skilled in the art, it is understood that the use of phrase(s) “is,” “are,” “may,” “can,” “could,” “will,” “should,” or the like, is for understanding various embodiments of the present disclosure and the phrases do not limit the disclosure or its implementation in any manner.

It is emphasized that the term “comprises” or “comprising” is used in this specification to specify the presence of stated features, integers, steps or components, but does not preclude the addition of one or more further features, integers, steps or components, or groups thereof.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above described system and/or the apparatus and/or any electronic device (not shown).

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms are deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to most effectively convey the substance of their work to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as “printing,” or “prioritizing,” or “displaying,” or “providing,” or “detecting,” “or receiving,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above-disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for re-ordering one or more print jobs listed in a print queue of a printer, the method implemented by the printer, comprising:
executing one or more already received print jobs listed in a print queue of a printer;
receiving a new print job in the print queue of the printer;
receiving a set of papers in a paper supply tray of the printer;
detecting the set of papers inserted in the paper supply tray of the printer;
after detecting the set of papers in the paper supply tray, displaying a message with an option to re-order the new print job in a pre-defined time, via a user interface;
based on a user input to the displayed message, receiving credentials of the user;
based on the received credentials of the user, checking whether the user belongs to an authorized group of users;
based on the detection of the set of papers in the paper supply tray and based on the check that the user belongs to the authorized group of users, re-ordering the new print job by moving the new print job to the top of the print queue of the printer; and
printing the new print job first followed by printing the one or more already received print jobs,
wherein the method allows only the authorized user to re-order the new print job.

2. The method of claim 1, wherein the set of papers belongs to a custom set of papers.

3. The method of claim 1, further comprising providing an option to the user to add one or more new print jobs.

4. The method of claim 3, wherein the one or more new print jobs are added from at least one of a Universal Serial Bus (USB), a network and a printer memory.

5. The method of claim 1, further comprising checking whether the print queue is empty.

6. The method of claim 1, wherein the new print job is a secure print job.

7. The method of claim 1, further comprising resuming printing of the one or more already received print jobs.

8. (canceled)

9. The method of claim 1, further comprising updating the print queue of the printer.

10. The method of claim 1, wherein the method is implemented by a non-transitory computer readable storage medium.

11. A printer, comprising:
a paper supply tray configured for receiving a set of papers;
a user interface configured for displaying a print queue listing one or more already received print jobs for printing; and
a print controller in communication with the paper supply tray and the user interface, the print controller configured for:
executing the one or more already received print jobs;
receiving a new print job in the print queue, the new print job being added to the print queue;
receiving a set of papers in the paper supply tray;
detecting the set of papers inserted in the paper supply tray;
after detecting the set of papers in the paper supply tray, displaying a message with an option to re-order the new print job in a pre-defined time, via the user interface;
based on a user input to the displayed message, receiving credentials of the user;
based on the received credentials of the user, checking whether the user belongs to an authorized group of users;
based on the detection of the set of papers in the paper supply tray and based on the check that the user belongs to the authorized group of users, re-ordering the new print job by moving the new print job to the top of the print queue; and
printing the re-ordered new print job first followed by printing the one or more already received print jobs,
wherein the printer allows only the authorized user to re-order the new print job.

12. The printer of claim 11, wherein the set of papers belongs to a custom set of papers.

13. The printer or claim 11, wherein the set of papers belongs to standard papers.

14. The printer of claim 11, wherein the user interface is configured for providing an option to the user to add one or more new print jobs.

15. The printer of claim 14, wherein the one or more new print jobs are added from at least one of a Universal Serial Bus (USB), a network and a printer memory.

16. The printer of claim 11, wherein the print controller is configured for checking whether the print queue is empty.

17. The printer of claim 11, wherein the new print job is a secure print job.

18. (canceled)

19. A method, comprising:
receiving a new print job in a print queue of a printer, the print queue of the printer comprising one or more already received print jobs;
detecting that a set of papers has been inserted in a paper supply tray of the printer;
presenting a user interface to a user with an option to re-order the new print job in a pre-defined time, wherein the user is an authorized user;
based on the detection of the set of papers in the paper supply tray and based on a user input to the presented option, prioritizing the new print job by moving the new print job to the top of the print queue;
pausing a currently executed print job of the one or more already received print jobs;
printing the new print job; and
resuming printing of the currently executed print job of the one or more already received print jobs,
wherein the method allows only the authorized user to re-order the new print job.

20. The method of claim 19, further comprising providing an option to the user to add one or more new print jobs.

21. The method of claim 19, wherein the one or more new print jobs are added from at least one of: a Universal Serial Bus (USB), a network and a printer memory.

22. The method of claim 19, wherein the new print job is a secure print job.

23. The method of claim 19, wherein the user interface provides the option to re-order the new print job when the set of papers is in the paper supply tray.

24. The method of claim 19, wherein the user interface provides an option for the user to re-order the new print job.

25. The method of claim 19, wherein the user is an authorized user.
